(19) United States
(12) Patent Application Publication
(10) Pub. No.: US 2026/0244894 A1
(43) Pub. Date: Aug. 20, 2026

(54) SESSION-BASED RECOMMENDATION UTILIZING SIMILARITY GRAPH

(71) Applicant: Intel Corporation, Santa Clara, CA (US)

(72) Inventors: Rita Brugarolas Brufau, Hillsboro, OR (US); Xinyao Wang, Shanghai (CN); Eric Anderson, Chandler, AZ (US); Ke Ding, San Jose, CA (US); Chendi Xue, Shanghai (CN); Jian Zhang, Shanghai (CN); Yu Zhou, Shanghai (CN)

(21) Appl. No.: 18/870,249

(22) PCT Filed: Sep. 30, 2022
(86) PCT No.: PCT/CN2022/123655

§ 371 Date: Nov. 27, 2024

(30) Foreign Application Priority Data
Jul. 1, 2022 (WO) PCT/CN2022/103215

(51) Int. Cl. G06N 3/042

(52) U.S. Cl. CPC G06N 3/042

(57) ABSTRACT

The application relates to session-based recommendation. A method for session-based recommendation may include: generating a similarity graph comprising a plurality of nodes and one or more edges, each node corresponding to an individual session and an edge being generated to connect two nodes in the similarity graph, wherein a similarity score of a pair of sessions corresponding to the two nodes exceeds a preset similarity threshold; and loading the similarity graph into a Graph Neural Network (GNN) for the session-based recommendation.

### TECHNICAL FIELD

Embodiments described herein generally relate to neural network technology, and more particularly relate to a method and an apparatus for session-based recommendation utilizing a similarity graph.

### BACKGROUND

Recommender systems (RSs) have been playing an increasingly important role for informed consumption, services, and decision-making in the overloaded information era and digitized economy. In recent years, session-based recommender systems (SBRSs) have emerged as a new paradigm of RSs.

### BRIEF DESCRIPTION OF THE DRAWINGS

The various advantages of the embodiments will become apparent to one skilled in the art by reading the following specification and appended claims, and by referencing the following drawings, in which:

FIG. 1 illustrates an example procedure for generating a similarity graph and training a Graphic Neural Network (GNN) for session-based recommendation according to some embodiments of the present disclosure;

FIG. 2 illustrates an example representation of sessions in an example dataset for session-based recommendation according to some embodiments of the present disclosure;

FIG. 3 illustrates an example procedure for utilizing a similarity graph in an existing or future session-based recommendation network according to some embodiments of the present disclosure;

FIG. 4 illustrates a flowchart of an example procedure for session-based recommendation utilizing a similarity graph according to some embodiments of the present disclosure;

FIG. 5 is a block diagram of an example processor platform structured to execute and/or instantiate machine readable instructions and/or operations to implement example procedures according to some embodiments of the present disclosure;

FIG. 6 is a block diagram of an example implementation of the processor circuitry of FIG. 5.

FIG. 7 is a block diagram of another example implementation of the processor circuitry of FIG. 5.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well-known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

SBRSs have emerged with increasing attention in recent years. Different from traditional RSs (e.g. content-based, collaborative filtering-based), SBRSs learn users' preferences from sessions associated and generated during consumption processes. Each session is composed of multiple user-item interactions that happen together in a continuous period of time, e.g., a basket of products purchased in one transaction visit, which usually lasts for several minutes to several hours. By taking each session as the basic input unit, an SBRS is able to capture both a user's short-term preference from his/her recent sessions and the preference dynamics reflecting the change of preferences from one session to another for more accurate and timely recommendations.

Currently, most solutions for session-based recommendation (SBR) aim to capture users' preferences only from their own session sequence, but fewer attempts have been taken to exploit global context from other users' sessions that may have similar preferences. A recently proposed Global Context Enhanced Graph Neural Network (GCE-GNN) (https://arxiv.org/abs/2106.05081) incorporates global context by modeling pairwise item-transitions over all sessions, but fails to capture pairwise full-session (complete session sequence) similarities.

Although consistent item-transitions across sessions can reveal item preferences or item similarities, they cannot capture the complete user session intent of the full sequence. To illustrate this with a fashion recommendation problem: common item-transitions would capture items that go well together, or similar items that a user may compare, but a session-based similarity is able to capture a full session intent (e.g. a user is searching for a specific item category (i.e. pants or shoes)) or a full business outfit (e.g. suit, heels, complements, etc.).

In the present disclosure, a novel solution for session-based recommendation is proposed to incorporate global context from all sessions that relies on full-session similarity instead of matching item-transitions. According to the proposed solution, the similarity across all pairs of sessions may be determined and similar sessions may be leveraged for generating more accurate next item predictions.

According to some embodiments of the present disclosure, a session-based recommendation approach may include calculating pairwise session similarities and constructing a similarity graph to exploit similar sessions (e.g. neighbor nodes in the similarity graph) for next item recommendation.

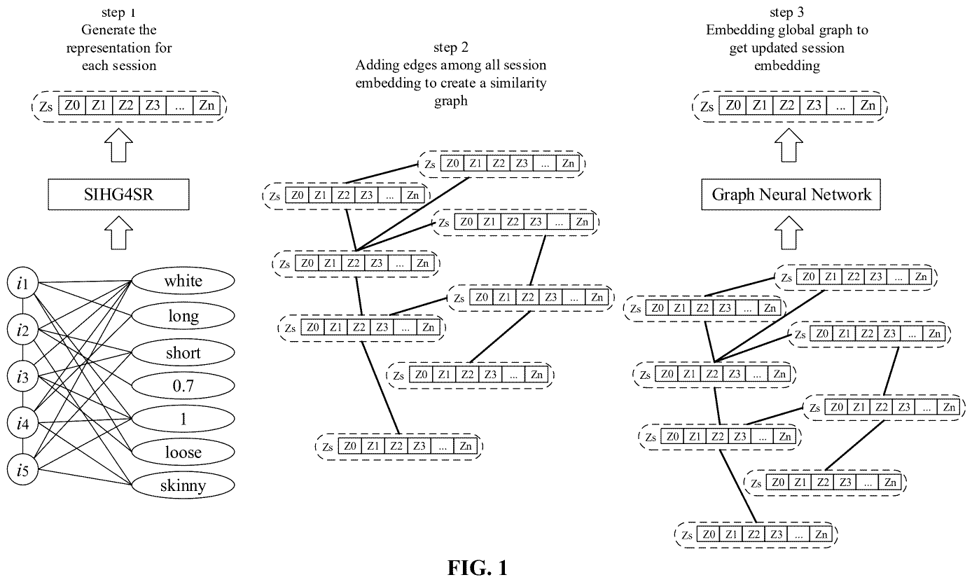

FIG. 1 illustrates an example procedure for generating a similarity graph and training a GNN for session-based recommendation according to some embodiments of the present disclosure. The example procedure may include generating the representation for each session (step 1). For example, an individual session may be represented with an embedding list generated from a recommendation model pre-trained with individual sessions. As shown in FIG. 1, in the example procedure, an Intel® developed model SIHG4SR for RecSys Challenge 2022 may be used as the pre-trained recommendation model for generating representations for individual sessions, but it can be understood that the representations for individual sessions can be generated by a different model, which is not limited herein.

Then the example procedure may include generating a similarity graph (step 2). A graph consists of a set of nodes and a set of edges connecting pairs of nodes indicating a relationship between them. Nodes and Edges can have associated features. According to some embodiments, the similarity graph may be defined as including a plurality of nodes and one or more edges. In the similarity graph, each node may correspond to an individual session, features of each node may correspond to the embeddings in the embedding list of the session generated in step 1, and an edge may be generated to connect two nodes when a similarity score of a pair of sessions corresponding to the two nodes exceeds a preset similarity threshold.

In some embodiments, for each node, a multi-hot encoding session fingerprint that encodes presence of item categories and values associated with the individual session may be generated, and then the similarity score of any pair of sessions may be calculated based on a similarity score between a pair of session fingerprints of the pair of sessions.

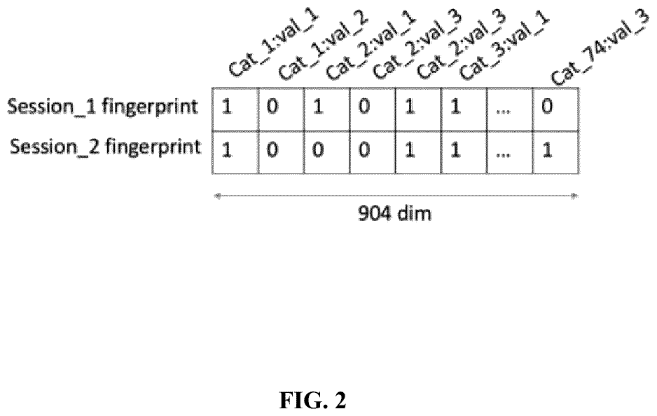

FIG. 2 illustrates an example representation of sessions in an example dataset for session-based recommendation according to some embodiments of the present disclosure. As shown in FIG. 2, an individual session may be represented by a fixed size multi-hot encoding session fingerprint that encodes presence of item categories and values associated with the individual session.

Taking a RecSys Challenge 2022 dataset as an example, content data of an item may be representative of a “category: value” taxonomy. Items may have more than one category, and for the same category, the items may have more than one associated values. Intuitively, items of diverse types (e.g. shoes vs. pants) may not share any categories and items of the same type (e.g. night vs. business dress) may share most categories.

Specifically, this dataset includes 74 categories and a total of 904 distinctive category-value pairs. Thus an item fingerprint of a 904-dimension array may be defined with multi-hot encoding. For each item, the item fingerprint may include a logical ‘1’ for all category-value pairs in the content data of the item. Then to generate a session fingerprint of a session that reflects all items explored within the session, the item fingerprints of all items in the session may be aggregated by a logical OR operation on the item fingerprints of all items in the session. As a result, the session fingerprint is also a 904-dimension array, as shown in FIG. 2.

Here, it is noted that in practice, the session fingerprint may be generated by aggregating item fingerprints of all or a subset of items in the session, e.g. by a logical OR operation or a different function. In other words, the way to generate a session fingerprint may be modified by a user according to specific application scenarios. For example, in some scenarios, some items may be not considered for generating the session fingerprint, e.g. very frequent items or items out of catalog. The user may select an appropriate operation to aggregate all or a subset of item fingerprints so as to generate the session fingerprint.

Next, for each pair of sessions in the dataset, the similarity score of the pair of sessions may be calculated based on a similarity score between a pair of session fingerprints of the pair of sessions. For example, the similarity score between the pair of session fingerprints may include a Jaccard similarity score, a cosine similarity score, an Euclidean similarity score, a hamming similarity score, a tanimoto similarity score or any other potential similarity score between the pair of session fingerprints.

It is noted that to address different recommendation problems, domain specific session fingerprints may be defined for datasets corresponding to the different recommendation problems. In other words, the session fingerprint is not limited to the fixed size multi-hot encoding session fingerprint herein. Accordingly, the specific fingerprint construction and corresponding similarity metric choice may be customized for specific recommendation problems. The specific definition of an item fingerprint of an item in a session shall be changed depending on the recommendation dataset to represent presence or not of substructures or features of the item.

With the calculated similarity scores of all pairs of sessions, a similarity threshold may be set so as to generate an edge for connecting two nodes in the similarity graph when a similarity score of a pair of sessions corresponding to the two nodes exceeds the similarity threshold. For example, the similarity threshold may be empirically set as 0.98, and thus when a similarity score of a pair of sessions exceeds 0.98, an edge may be generated in the similarity graph to connect two nodes corresponding to the pair of sessions. In this case, the resulting similarity graph may be a graph having about 1 million nodes with an average node degree of 8.2.

With continued reference to FIG. 1, the example procedure may further include training a GNN to exploit global context from neighbor sessions (step 3). For the above mentioned fashion recommendation problem posed in RecSys Challenge 2022, the GNN may be consisted on a two-layer Graph Attention Network (GAT) followed by two linear and Relu activations and an output linear layer to match the dimensions of the output features to that of the input embeddings. Once the similarity graph is generated, the similarity graph may be loaded into the GNN which may be trained with one or more similar neighbor sessions of each session. For example, the training of the GNN may be implemented by leveraging a Pytorch Geometric (PyG) neighbor loader to fit the similarity graph into a pytorch trainer.

As mentioned above, each session may be represented with an embedding list generated from a recommendation model pre-trained with individual sessions. The training of the recommendation model with individual sessions may be referred to as the first phase training, and the training of the GNN loaded with the similarity graph may be referred to as the second phase training which is implemented based on similar neighbor sessions. The second phase training may help to calibrate the first phase individual session prediction (e.g. from the pre-trained recommendation model SIHG4SR) with the global context provided by similar neighbor sessions.

Furthermore, according to some embodiments of the present disclosure, the way of utilizing the similarity graph to calibrate the representation for each session may be adaptable for other models. For example, the similarity graph may work as a plugin for any mature or future pipelines.

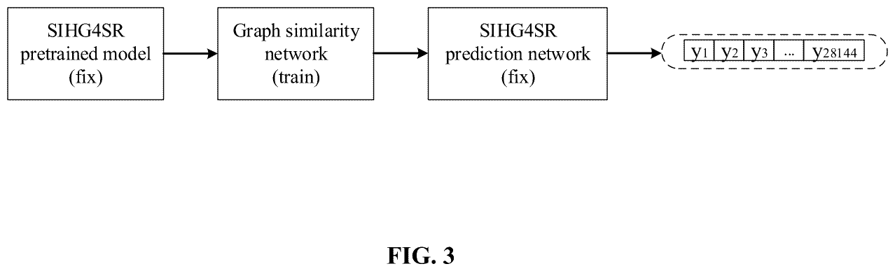

FIG. 3 illustrates an example procedure for utilizing a similarity graph in an existing or future session-based recommendation network according to some embodiments of the present disclosure. For example, the similarity graph may be plugged into the base model SIHG4SR for RecSys Challenge 2022. As shown in FIG. 3, the session embeddings (i.e. node features in the similarity graph) may be generated based on the pertained SIHG4SR model so as to generate the similarity graph, and then the similarity graph may be utilized to calibrate the session representations for the SIHG4SR model. During the training, the learning parameters in the SIHG4SR model may be fixed and only the Graph Similarity Network may be trained with similar neighbor sessions to get updated session embeddings for enhancing the session representations for the SIHG4SR model. Then the enhanced session representations may be applied to a SIHG4SR prediction network to get a final prediction.

It is noted that although the session-based recommendation approach is described above with respect to the RecSys Challenge 2022 for fashion recommendation in some embodiments of the present disclosure, the approach may be adaptable to address other recommendation problems for which a domain specific session fingerprint may be defined.

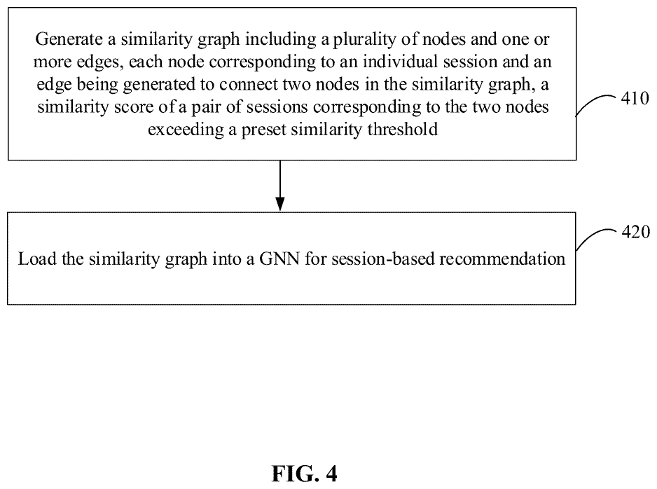

For better understanding an overall idea for the proposed session-based recommendation approach in the disclosure, an example procedure for session-based recommendation utilizing a similarity graph will be further described with reference to the flowchart shown in FIG. 4.

FIG. 4 illustrates a flowchart of an example procedure for session-based recommendation utilizing a similarity graph according to some embodiments of the present disclosure. The procedure may be implemented by a processor circuitry and may include operations 410 and 420.

At operation 410, the processor circuitry may generate a similarity graph including a plurality of nodes and one or more edges. In the similarity graph, each node may correspond to an individual session, and an edge may be generated to connect two nodes. A similarity score of a pair of sessions corresponding to the two nodes in the similarity graph may exceed a preset similarity threshold.

At operation 420, the processor circuitry may load the similarity graph into a GNN for the session-based recommendation.

According to some embodiments, the individual session may be represented with an embedding list generated from a recommendation model pre-trained with individual sessions.

According to some embodiments, the processor circuitry may train the GNN with one or more similar neighbor sessions of the individual session.

According to some embodiments, the processor circuitry may generate the similarity graph by: generating, for each node, a multi-hot encoding session fingerprint that encodes presence of item categories and values associated with the individual session; and calculating the similarity score of the pair of sessions based on a similarity score between a pair of session fingerprints of the pair of sessions.

According to some embodiments, the similarity score between the pair of session fingerprints may include a Jaccard similarity score, a cosine similarity score, an Euclidean similarity score, a hamming similarity score, a tanimoto similarity score or any other potential similarity score between the pair of session fingerprints.

According to some embodiments, the multi-hot encoding session fingerprint may be of a fixed size.

According to some embodiments, the multi-hot encoding session fingerprint may be generated by aggregating item fingerprints of all or a subset of items in the individual session.

According to some embodiments, for each item in the individual session, an item fingerprint of the item may be defined depending on a recommendation dataset for the session-based recommendation to represent presence or not of substructures or features of the item.

According to some embodiments, the processor circuitry may further load the similarity graph into a session-based recommendation network to calibrate session representations in the session-based recommendation network based on the similarity graph.

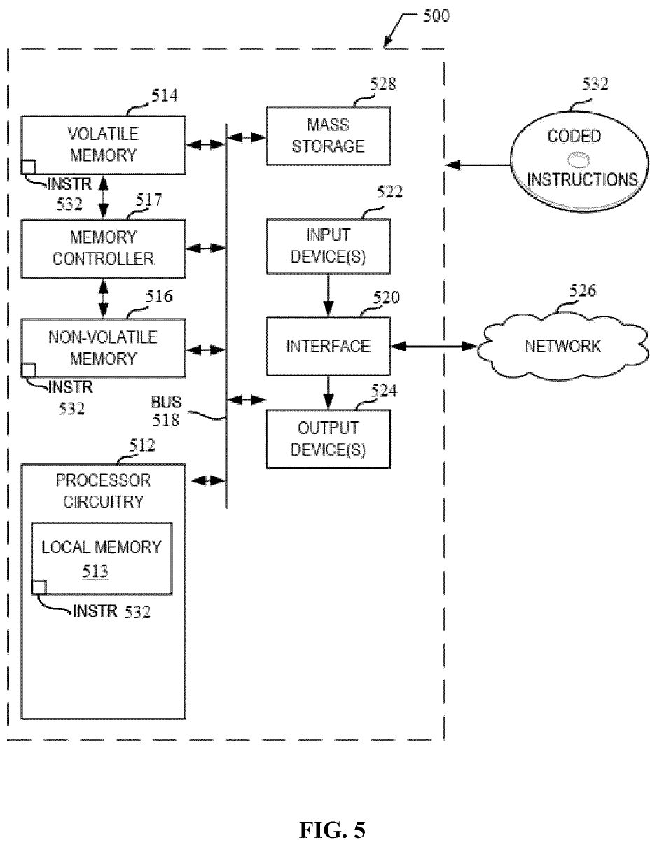

FIG. 5 is a block diagram of an example processor platform 500 structured to execute and/or instantiate machine readable instructions and/or operations to implement example procedures according to some embodiments of the present disclosure. The processor platform 500 can be, for example, a server, a personal computer, a workstation, a self-learning machine (e.g., a neural network), a mobile device (e.g., a cell phone, a smart phone, a tablet such as an iPad™), an Internet appliance, a DVD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 500 of the illustrated example includes processor circuitry 512. The processor circuitry 512 of the illustrated example is hardware. For example, the processor circuitry 512 can be implemented by one or more integrated circuits, logic circuits, FPGAs microprocessors, CPUs, GPUs, DSPs, and/or microcontrollers from any desired family or manufacturer. The processor circuitry 512 may be implemented by one or more semiconductor based (e.g., silicon based) devices.

The processor circuitry 512 of the illustrated example includes a local memory 513 (e.g., a cache, registers, etc.). The processor circuitry 512 of the illustrated example is in communication with a main memory including a volatile memory 514 and a non-volatile memory 516 by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517.

The processor platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 522 are connected to the interface circuitry 520. The input device(s) 522 permit(s) a user to enter data and/or commands into the processor circuitry 512. The input device(s) 522 can be implemented by, for example, an audio sensor, a microphone, a camera (still or video), a keyboard, a button, a mouse, a touchscreen, a track-pad, a trackball, an isopoint device, and/or a voice recognition system.

One or more output devices 524 are also connected to the interface circuitry 520 of the illustrated example. The output devices 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 500 of the illustrated example also includes one or more mass storage devices 528 to store software and/or data. Examples of such mass storage devices 528 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 532 may be stored in the mass storage device 528, in the volatile memory 514, in the non-volatile memory 516, and/or on a removable non-transitory computer readable storage medium such as a CD or DVD.

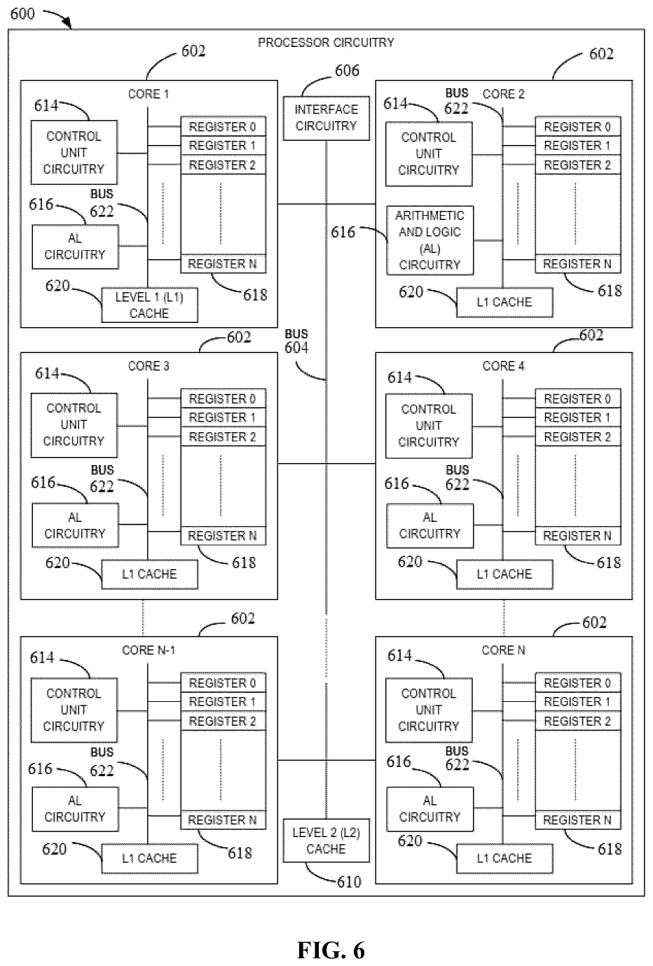

FIG. 6 is a block diagram of an example implementation of the processor circuitry 512 of FIG. 5. In this example, the processor circuitry 512 of FIG. 5 is implemented by a microprocessor 600. For example, the microprocessor 600 may implement multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations discussed herein.

The cores 602 may communicate by an example bus 604. In some examples, the bus 604 may implement a communication bus to effectuate communication associated with one(s) of the cores 602. For example, the bus 604 may implement at least one of an Inter-Integrated Circuit (I2C) bus, a Serial Peripheral Interface (SPI) bus, a PCI bus, or a PCIe bus. Additionally or alternatively, the bus 604 may implement any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2_cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the L1 cache 620, and an example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating point operations. In yet other examples, the AL circuitry 616 may include first AL circuitry that performs integer based operations and second AL circuitry that performs floating point operations. In some examples, the AL circuitry 616 may be referred to as an Arithmetic Logic Unit (ALU). The registers 618 are semiconductor-based structures to store data and/or instructions such as results of one or more of the operations performed by the AL circuitry 616 of the corresponding core 602. For example, the registers 618 may include vector register(s), SIMD register(s), general purpose register(s), flag register(s), segment register(s), machine specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure including distributed throughout the core 602 to shorten access time. The bus 620 may implement at least one of an I2C bus, a SPI bus, a PCI bus, or a PCIe bus

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

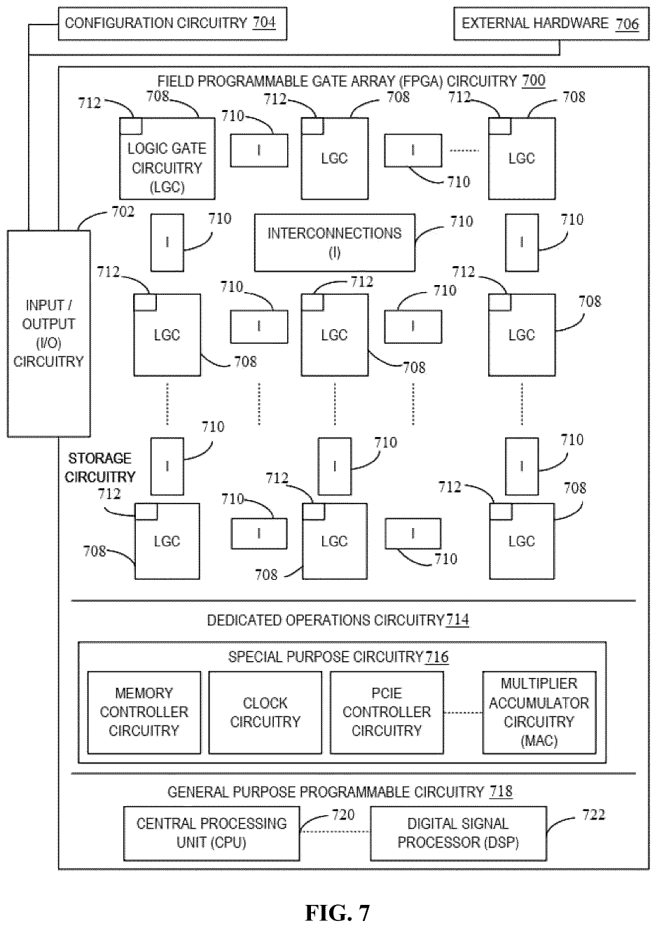

FIG. 7 is a block diagram of another example implementation of the processor circuitry 512 of FIG. 5. In this example, the processor circuitry 600 is implemented by FPGA circuitry 700. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the machine readable instructions in hardware and, thus, can often execute the operations faster than they could be performed by a general purpose microprocessor executing the corresponding software.

More specifically, in contrast to the microprocessor 600 of FIG. 6 described above (which is a general purpose device that may be programmed to execute some or all of the operations disclosed herein but whose interconnections and logic circuitry are fixed once fabricated), the FPGA circuitry 700 of the example of FIG. 7 includes interconnections and logic circuitry that may be configured and/or interconnected in different ways after fabrication to instantiate. In particular, the FPGA 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the software represented by the operations discussed herein. As such, the FPGA circuitry 700 may be structured to effectively instantiate some or all of the machine readable instructions representing the operations discussed herein as dedicated logic circuits to perform the operations corresponding to those software instructions in a dedicated manner analogous to an ASIC. Therefore, the FPGA circuitry 700 may perform the operations corresponding to the some or all of the operations discussed herein faster than the general purpose microprocessor can execute the same.

In the example of FIG. 7, the FPGA circuitry 700 is structured to be programmed (and/or reprogrammed one or more times) by an end user by a hardware description language (HDL) such as Verilog. The FPGA circuitry 700 of FIG. 7, includes example input/output (I/O) circuitry 702 to obtain and/or output data to/from example configuration circuitry 704 and/or external hardware (e.g., external hardware circuitry) 706. For example, the configuration circuitry 704 may implement interface circuitry that may obtain machine readable instructions to configure the FPGA circuitry 700, or portion(s) thereof. In some such examples, the configuration circuitry 704 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 706 may implement the microprocessor 600 of FIG. 6. The FPGA circuitry 700 also includes an array of example logic gate circuitry 708, a plurality of example configurable interconnections 710, and example storage circuitry 712. The logic gate circuitry 708 and interconnections 710 are configurable to instantiate one or more operations discussed herein and/or other desired operations. The logic gate circuitry 708 shown in FIG. 7 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations. The logic gate circuitry 708 may include other electrical structures such as look-up tables (LUTs), registers (e.g., flip-flops or latches), multiplexers, etc.

The interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example Dedicated Operations Circuitry 714. In this example, the Dedicated Operations Circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the processor circuitry 512 of FIG. 5, many other approaches are contemplated. For example, as mentioned above, modern FPGA circuitry may include an on-board CPU, such as one or more of the example CPU 720 of FIG. 7. Therefore, the processor circuitry 512 of FIG. 5 may additionally be implemented by combining the example microprocessor 600 of FIG. 6 and the example FPGA circuitry 700 of FIG. 7. In some such hybrid examples, a first portion of the machine readable instructions may be executed by one or more of the cores 602 of FIG. 6 and a second portion of the machine readable instructions may be executed by the FPGA circuitry 700 of FIG. 7.

In some examples, the processor circuitry 512 of FIG. 5 may be in one or more packages. For example, the processor circuitry 600 of FIG. 6 and/or the FPGA circuitry 700 of FIG. 7 may be in one or more packages. In some examples, an XPU may be implemented by the processor circuitry 512 of FIG. 5, which may be in one or more packages. For example, the XPU may include a CPU in one package, a DSP in another package, a GPU in yet another package, and an FPGA in still yet another package.

In various embodiments, the operations discussed herein may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Although embodiments have been described in language specific to structural features and/or methodological acts, it is to be understood that claimable subject matter may not be limited to the specific features or acts described. Rather, the specific features and acts are disclosed as sample forms of implementing the claimable subject matter.

### ADDITIONAL NOTES AND EXAMPLES

Example 1 includes an apparatus for session-based recommendation, comprising: interface circuitry; and processor circuitry coupled to the interface circuitry and configured to: generate a similarity graph comprising a plurality of nodes and one or more edges, each node corresponding to an individual session and an edge being generated to connect two nodes in the similarity graph, wherein a similarity score of a pair of sessions corresponding to the two nodes exceeds a preset similarity threshold; and provide the similarity graph to the interface circuitry for loading into a Graph Neural Network (GNN) for the session-based recommendation.

Example 2 includes the apparatus of Example 1, wherein the individual session is represented with an embedding list generated from a recommendation model pre-trained with individual sessions.

Example 3 includes the apparatus of Example 1 or 2, wherein the processor circuitry is further configured to train the GNN with one or more similar neighbor sessions of the individual session.

Example 4 includes the apparatus of any of Examples 1 to 3, the processor circuitry is configured to generate the similarity graph by: generating, for each node, a multi-hot encoding session fingerprint that encodes presence of item categories and values associated with the individual session; and calculating the similarity score of the pair of sessions based on a similarity score between a pair of session fingerprints of the pair of sessions.

Example 5 includes the apparatus of Example 4, wherein the similarity score between the pair of session fingerprints comprises at least one of a Jaccard similarity score, a cosine similarity score, an Euclidean similarity score, a hamming similarity score, or a tanimoto similarity score between the pair of session fingerprints.

Example 6 includes the apparatus of Example 4, wherein the multi-hot encoding session fingerprint is of a fixed size.

Example 7 includes the apparatus of Example 4, wherein the multi-hot encoding session fingerprint is generated by aggregating item fingerprints of all or a subset of items in the individual session.

Example 8 includes the apparatus of Example 7, wherein for each item in the individual session, an item fingerprint of the item is defined depending on a recommendation dataset for the session-based recommendation to represent presence or not of substructures or features of the item.

Example 9 includes the apparatus of any of Examples 1 to 8, wherein the processor circuitry is further configured to provide the similarity graph to the interface circuitry for loading into a session-based recommendation network to calibrate session representations in the session-based recommendation network based on the similarity graph.

Example 10 includes a method for session-based recommendation, comprising: generating a similarity graph comprising a plurality of nodes and one or more edges, each node corresponding to an individual session and an edge being generated to connect two nodes in the similarity graph, wherein a similarity score of a pair of sessions corresponding to the two nodes exceeds a preset similarity threshold; and loading the similarity graph into a Graph Neural Network (GNN) for the session-based recommendation.

Example 11 includes the method of Example 10, wherein the individual session is represented with an embedding list generated from a recommendation model pre-trained with individual sessions.

Example 12 includes the method of Example 10 or 11, further comprising training the GNN with one or more similar neighbor sessions of the individual session.

Example 13 includes the method of any of Examples 10 to 12, wherein generating the similarity graph comprises: generating, for each node, a multi-hot encoding session fingerprint that encodes presence of item categories and values associated with the individual session; and calculating the similarity score of the pair of sessions based on a similarity score between a pair of session fingerprints of the pair of sessions.

Example 14 includes the method of Example 13, wherein the similarity score between the pair of session fingerprints comprises at least one of a Jaccard similarity score, a cosine similarity score, an Euclidean similarity score, a hamming similarity score, or a tanimoto similarity score between the pair of session fingerprints.

Example 15 includes the method of Example 13, wherein the multi-hot encoding session fingerprint is of a fixed size.

Example 16 includes the method of Example 13, wherein the multi-hot encoding session fingerprint is generated by aggregating item fingerprints of all or a subset of items in the individual session.

Example 17 includes the method of Example 16, wherein for each item in the individual session, an item fingerprint of the item is defined depending on a recommendation dataset for the session-based recommendation to represent presence or not of substructures or features of the item.

Example 18 includes the method of any of Examples 10 to 17, further comprising: loading the similarity graph into a session-based recommendation network to calibrate session representations in the session-based recommendation network based on the similarity graph.

Example 19 includes a computer-readable medium having instructions stored thereon, wherein the instructions, when executed by processor circuitry, cause the processor circuitry to perform any method of Examples 10 to 18.

Example 20 includes an apparatus, comprising means for performing any method of Examples 10 to 18.

Various techniques, or certain aspects or portions thereof, may take the form of program code (i.e., instructions) embodied in tangible media, such as floppy diskettes, CD-ROMs, hard drives, non-transitory computer readable storage medium, or any other machine-readable storage medium, wherein, when the program code is loaded into and executed by a machine, such as a computer, the machine becomes an apparatus for practicing the various techniques. The non-transitory computer readable storage medium may be a computer readable storage medium that does not include signal. In the case of program code execution on programmable computers, the computing system may include a processor, a storage medium readable by the processor (including volatile and non-volatile memory and/or storage elements), at least one input device, and at least one output device. The volatile and non-volatile memory and/or storage elements may be a RAM, EPROM, flash drive, optical drive, magnetic hard drive, solid state drive, or other medium for storing electronic data. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Exemplary systems or devices may include without limitation, laptop computers, tablet computers, desktop computers, smart phones, computer terminals and servers, storage databases, and other electronics which utilize circuitry and programmable memory, such as household appliances, smart televisions, digital video disc (DVD) players, heating, ventilating, and air conditioning (HVAC) controllers, light switches, and the like.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1-20. (canceled)

21. An apparatus for session-based recommendation, the apparatus comprising:
interface circuitry;
machine-readable instructions; and
at least one processor circuit to be programmed based on the machine-readable instructions to:
generate a similarity graph including a plurality of nodes and one or more edges, a first node corresponding to an individual session and an edge being generated to connect two nodes in the similarity graph, wherein a similarity score of a pair of sessions corresponding to the two nodes exceeds a preset similarity threshold; and
provide the similarity graph to the interface circuitry to cause the similarity graph to be loaded into a Graph Neural Network (GNN) for the session-based recommendation.

22. The apparatus of claim 21, wherein the individual session is represented with an embedding list generated from a recommendation model pre-trained with individual sessions.

23. The apparatus of claim 21, wherein one or more of the at least one processor circuit is to train the GNN with one or more similar neighbor sessions of the individual session.

24. The apparatus of claim 21, wherein one or more of the at least one processor circuit is to generate the similarity graph by:
generating, for the first node, a multi-hot encoding session fingerprint that encodes presence of item categories and values associated with the individual session; and
calculating the similarity score of the pair of sessions based on a similarity score between a pair of session fingerprints of the pair of sessions.

25. The apparatus of claim 24, wherein the similarity score between the pair of session fingerprints includes at least one of a Jaccard similarity score, a cosine similarity score, an Euclidean similarity score, a hamming similarity score, or a tanimoto similarity score between the pair of session fingerprints.

26. The apparatus of claim 24, wherein the multi-hot encoding session fingerprint is of a fixed size.

27. The apparatus of claim 24, wherein the multi-hot encoding session fingerprint is generated by aggregating item fingerprints of all or a subset of items in the individual session.

28. The apparatus of claim 27, wherein for an item in the individual session, an item fingerprint of the item is defined depending on a recommendation dataset for the session-based recommendation to represent presence or not of substructures or features of the item.

29. The apparatus of claim 21, wherein one or more of the at least one processor circuit is to provide the similarity graph to the interface circuitry to cause the similarity graph to be loaded into a session-based recommendation network to calibrate session representations in the session-based recommendation network based on the similarity graph.

30. A method for session-based recommendation, the method comprising:
generating, by at least one processor circuit programmed by at least one instruction, a similarity graph including a plurality of nodes and one or more edges, a first node corresponding to an individual session and an edge being generated to connect two nodes in the similarity graph, wherein a similarity score of a pair of sessions corresponding to the two nodes exceeds a preset similarity threshold; and
loading the similarity graph into a Graph Neural Network (GNN) for the session-based recommendation.

31. The method of claim 30, wherein the individual session is represented with an embedding list generated from a recommendation model pre-trained with individual sessions.

32. The method of claim 30, including training the GNN with one or more similar neighbor sessions of the individual session.

33. The method of claim 30, wherein generating the similarity graph includes:
generating, for the first node, a multi-hot encoding session fingerprint that encodes presence of item categories and values associated with the individual session; and
calculating the similarity score of the pair of sessions based on a similarity score between a pair of session fingerprints of the pair of sessions.

34. The method of claim 33, wherein the similarity score between the pair of session fingerprints includes at least one of a Jaccard similarity score, a cosine similarity score, a Euclidean similarity score, a hamming similarity score, or a tanimoto similarity score between the pair of session fingerprints.

35. The method of claim 33, wherein the multi-hot encoding session fingerprint is of a fixed size.

36. The method of claim 33, wherein the multi-hot encoding session fingerprint is generated by aggregating item fingerprints of all or a subset of items in the individual session.

37. The method of claim 36, wherein for an item in the individual session, an item fingerprint of the item is defined depending on a recommendation dataset for the session-based recommendation to represent presence or not of substructures or features of the item.

38. The method of claim 30, including loading the similarity graph into a session-based recommendation network to calibrate session representations in the session-based recommendation network based on the similarity graph.

39. A non-transitory computer-readable medium comprising instructions to cause at least one processor circuit to at least:
generate a similarity graph including a plurality of nodes and one or more edges, a first node corresponding to an individual session and an edge being generated to connect two nodes in the similarity graph, wherein a similarity score of a pair of sessions corresponding to the two nodes exceeds a preset similarity threshold; and
load the similarity graph into a Graph Neural Network (GNN) for a session-based recommendation.

40. The computer-readable medium of claim 39, wherein to generate the similarity graph, the instructions are to cause one or more of the at least one processor circuit to:
generate, for the first node, a multi-hot encoding session fingerprint that encodes presence of item categories and values associated with the individual session; and
calculate the similarity score of the pair of sessions based on a similarity score between a pair of session fingerprints of the pair of sessions.
